(19) United States
(12) Patent Application Publication
(10) Pub. No.: US 2001/0055524 A1
(43) Pub. Date: Dec. 27, 2001

(54) Minibulk, dry animal feed delivery system

(76) Inventors: Timothy Jackson, Heath Springs, SC (US); Candice Walker, Mooresville, NC (US); Robert Wiltse, Altha, FL (US); Fred L. Hardison, Statesville, NC (US); Donald Blackmon, Lucama, NC (US); Keith E. Pike, Washington, MO (US)

Correspondence Address: WHYTE HIRSCHBOECK DUDEK S C, 111 EAST WISCONSIN AVENUE, SUITE 2100, MILWAUKEE, WI, 53202

(21) Appl. No.: 09/681,899

(22) Filed: Jun. 21, 2001

Related U.S. Application Data
(60) Provisional application No. 60/213,920, filed on Jun. 26, 2000.

(51) Int. Cl. B62B 1/00

(52) U.S. Cl. 414/467

(57) ABSTRACT

Minibulk quantities, e.g., 500-6000 pounds, of dry, free-flowing feed for large animals, e.g., horses, are delivered to small farms and ranches, e.g., less than fifteen horses, located remote from a distribution center for the feed by a method comprising the steps of: A. Filling a container sealable to the environment with a minibulk quantity of dry, free-flowing, manufactured animal feed at a distribution center for the feed, the container equipped with at least one sealable opening through which the feed can be loaded into and unloaded from the container; B. Transporting the filled container to the site remote from the center; C. Positioning the filled container onto a support rack at a location remote from the manufacturing center, the filled container positioned upon the support rack in a manner such that the feed flows under the force of gravity to the at least one sealable opening of the container; D. Recovering a container depleted of feed from the remote site; and E. Returning the container depleted of feed to the manufacturing center for refilling with feed.

### CROSS REFERENCE TO RELATED APPLICATIONS

This application claims the benefit of U.S. Provisional Application No. 60/213,920 filed Jun. 26, 2000.

### BACKGROUND OF INVENTION

The present invention relates generally to the transport and storage of animal feed and more particularly, to a method and assembly for delivering minibulk quantities of dry, free-flowing animal feed to sites remote from an animal feed distribution center. In another aspect, the invention relates to a method and assembly of storing the minibulk quantity of dry animal feed once delivered to the remote site.

Presently, all forms of dry animal feed (e.g., pellets, granules, etc.) for horses, cattle, sheep, goats and other animals, primarily large mammals but also including small mammals, e.g., rabbits, and non-mammals, e.g., birds and fish, are transported and stored in either bulk or bag quantities. Bulk or bulk quantities means amounts in excess of about three short tons (with a short ton equal to 2,000 pounds). Bags or bag quantities means amounts of about 50 pounds or less, with a typical bag containing 50 pounds of feed.

Shipping dry, manufactured animal feed in bulk quantities is more economical (on a cost per unit weight basis) than shipping in bag quantities due to economies of scale. However, to benefit from this economy of scale typically requires an on-site storage facility and a sufficiently large number of animals to consume the feed before it deteriorates due mold (typically from exposure to warm and humid weather conditions) or insect or rodent infestation.

Small ranches and farms, e.g., those with fifteen or fewer large animals (e.g., horses) that eat dry, manufactured animal feed, usually buy such feed in bag quantities. This avoids the need for an on-site storage facility and/or the loss of feed due to mold or insect or rodent infestation. As such small farms and ranches remote from the distribution center usually must make arrangements to pick-up their purchases of bag quantities of manufactured animal feed.

Thus, a need exists to serve small farms and ranches located at sites remote from a dry animal feed distribution center with the delivery and storage of minibulk quantities of dry animal feed. As here used, minibulk and minibulk quantities means an amount of manufactured, dry animal feed of between about one-quarter and three short tons, i.e., between about 500 and about 6000 pounds. As here used, remote from a dry animal feed distribution center means that the distance between the small farm, ranch, etc. and the dry animal feed distribution center is such that delivery of less than bulk quantities of dry animal feed is usually not available from the facility or it requires a separate charge. As here used, distribution center means any facility from which the dry animal feed is distributed to end users. Exemplary facilities include warehouses, dealer or agent facilities, and manufacturing facilities (in certain circumstances, the manufacturer of dry animal feed will distribute the feed to end users directly from its manufacturing facility). As here used, end users include ranchers, farmers and hobbyists, i.e., essentially anyone who raises and/or cares for animals that consume manufactured dry feed.

### SUMMARY OF INVENTION

According to one embodiment of this invention, minibulk quantities of dry animal feed are delivered to sites remote from a distribution center for the feed by a method comprising the steps of: A. Filling a container with a minibulk quantity of dry, free-flowing animal feed at a distribution center for the feed, the container equipped with at least one sealable opening through which the feed can be loaded into the container; B. Transporting the filled container to the site remote from the center; C. Positioning the filled container onto a support rack at the site remote from the distribution center, the filled container positioned upon the support rack in a manner such that gravity causes the feed to flow towards the at least one sealable opening of the container; D. Recovering from the remote site a container depleted of feed; and E. Returning the container depleted of feed to the distribution center.

Preferably, the container comprises a removable lid that sealingly engages one or more side walls, and the side walls sealingly engage a base equipped with a discharge opening. The base comprises one or more sections that slope inwardly and downwardly from the side walls to the discharge opening to form a cone-like configuration. The discharge opening is equipped with a gate that moves between an open and closed position to allow a discharge of dry, free-flowing animal feed from the container.

The rack is sized to receive and hold the container in a secured manner, and to allow the positioning of a transport device, e.g., a wheel barrow, beneath it to receive dry, free-flowing animal feed from the container when the discharge gate is in the open position.

In another embodiment of the invention, the filled container is transported to the remote site using a trailer equipped with a means for lifting and positioning the filled container onto the rack. In one embodiment, the trailer comprises a single axle supporting a U-shaped frame designed to securely receive, hold and transport the filled container from the distribution center to the remote site. The trailer is also equipped with a drive wheel powered by a motor that, once disconnected from the towing vehicle, allows the trailer to maneuver into a position from which the filled container can be transferred from the trailer to the rack.

In yet another embodiment of this invention, the container is not recovered from the rack at the remote site. Rather, the container remains on the rack at the remote site, and it is periodically refilled by a delivery truck equipped with means for transferring dry, free-flowing manufactured animal feed from the vehicle to the container. The transfer means typically comprises at least one pump and hose.

### BRIEF DESCRIPTION OF DRAWING

FIG. 1 is an isometric, cut-away view of one embodiment of a mini bulk feed container or bin that can be used in the practice of this invention.

FIG. 2 is a side view of the minibulk feed bin of FIG. 1 positioned on a trailer for towing to a remote site.

FIG. 3 is a partial side view of the trailer of FIG. 2 with the feed bin removed, and showing the hoist and rear gate.

FIG. 4 is a full side view of the trailer of FIG. 2 with a partial side view of the bin of FIG. 2.

FIG. 5 is a rear view of the trailer and bin of FIG. 2.

FIG. 6 is an enlarged, sectional view of the rear, left support strut of the trailer of FIG. 5.

FIG. 7 is an isometric view of the bin of FIG. 1 positioned on a support rack.

FIG. 8 is a rear view of the bin and support rack of FIG. 7 with a cut-away view of the lower section of the bin.

FIG. 9 is a block diagram of one embodiment of the method of this invention for delivering minibulk quantities of manufactured, dry, free-flowing animal feed to small ranches and farms remote from an animal feed distribution center.

FIGS. 10-19 illustrate a sequence of steps for the delivery of a filled minibulk feed bin to a remote site, and the return of an empty minibulk feed bin to a distribution center for refill.

FIG. 20 is an isometric view of an alternative design of a minibulk feed bin.

FIG. 21 is an elevated, isometric view of an alternative design of a support rack.

FIG. 22 is a side view of the position relative to one another of the rack of FIG. 21 and the bin of FIG. 20 during the transfer of the filled bin from a transport vehicle to the rack.

FIG. 23 is an enlarged, rear view of the rack of FIG. 21 illustrating one embodiment of adjusting the height of one set of support legs of the rack.

FIG. 24 is another alternative design of the minibulk feed bin.

FIG. 25 is a side view of an alternative embodiment of this invention in which the minibulk feed bin is refilled from a bulk feed transport.

### DETAILED DESCRIPTION

Although the following description of the invention is within the context of manufactured, free-flowing, dry horse feed (e.g., pellets, granules, etc.), the method and apparatus of this invention is applicable to other manufactured, free-flowing dry feeds for other agricultural or recreational animals (both large and small, mammals and non-mammal), e.g., cattle, goats, sheep, llamas, ostriches, pigs, rabbits, fish, etc. In the figures, like numerals are used to designate like parts throughout the same. Various items of equipment, such as fittings, fasteners, and the like, have been omitted so as to simplify the description. Those skilled in the art, however, will realize that such conventional equipment is employed as desired.

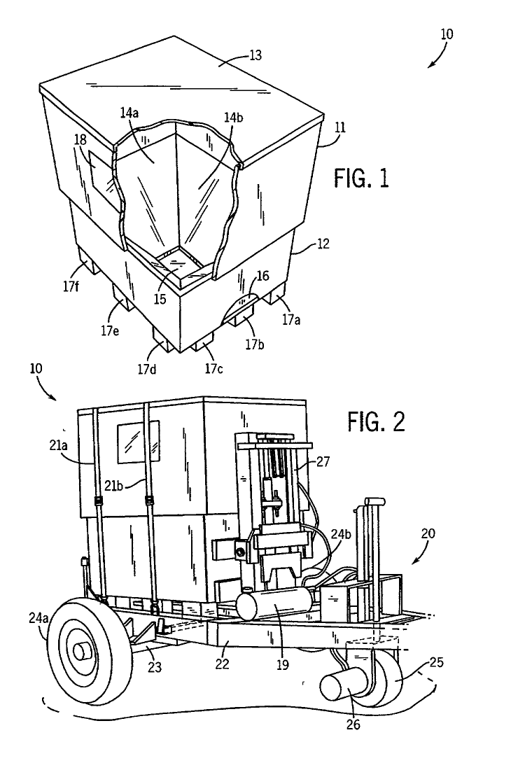

FIG. 1 illustrates two-part container 10 comprising ring 11 in sealed engagement with base 12. Ring 11 is also in a sealed engagement with removable lid 13, and base 12 comprises internal surfaces 14a-d (surfaces 14c-d not shown) that slope downwardly and inwardly to form discharge port 15. The inwardly slope of these surfaces is typically at least 30°, preferably at least 40° and more preferably at least about 50° . Ring 11 and base 12 can have any suitable shape, e.g., circular, rectangular, etc., but the shape of the ring usually follows the shape of the base, and vice versa .

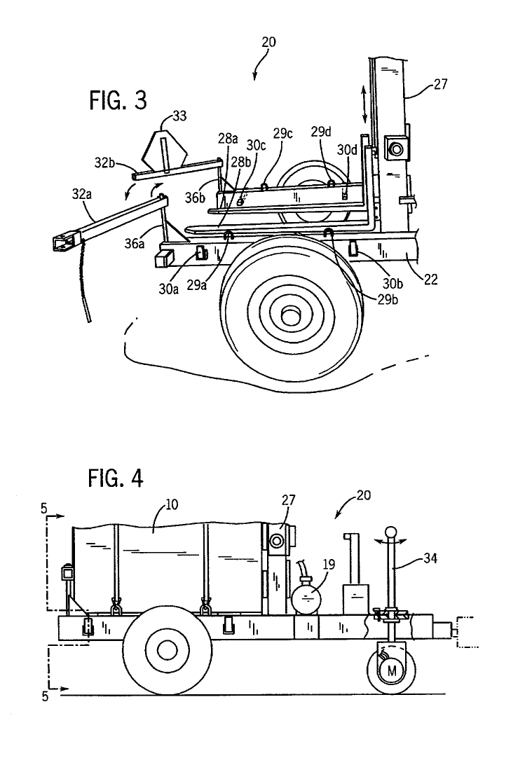

Whether or not discharge port 15 is open or closed is controlled by gate 16. In FIG. 1, gate 16 is in the closed position. Discharge port 15 is open when gate 16 is pulled back (not shown) from base 12. Bin 10 is supported on feet 17a-l feet g through l not shown), and these feet are spaced from one another such that tines of a forklift hoist (shown in FIG. 3) can fit beneath bin 10 to raise and lower it as necessary.

Bin 10 is constructed of any suitable material, but preferably it is constructed from a durable plastic (e.g., polyethylene, polypropylene, nylon, etc.). The plastic can be opaque, translucent or transparent and if opaque (e.g., pigmented), then preferably the bin is equipped with sight glass 18 so as to enable a viewer to determine the relative fill of the bin without removing the lid. The bid is constructed in such a manner that it is water-tight and the only entries to its interior are by removal of the lid from the ring and through the discharge port when the gate is in its open position (thus offering an effective barrier against rodents, birds and other animals (including insects) that might be interested in its contents). The bins manufactured by Buckhorn, Inc. of Milford, Ohio are representative of the bins that can be used in the practice of this invention, and these bins are further described in U.S. Pat. No. 6,01 0,022 the disclosure of which is incorporated herein by reference.

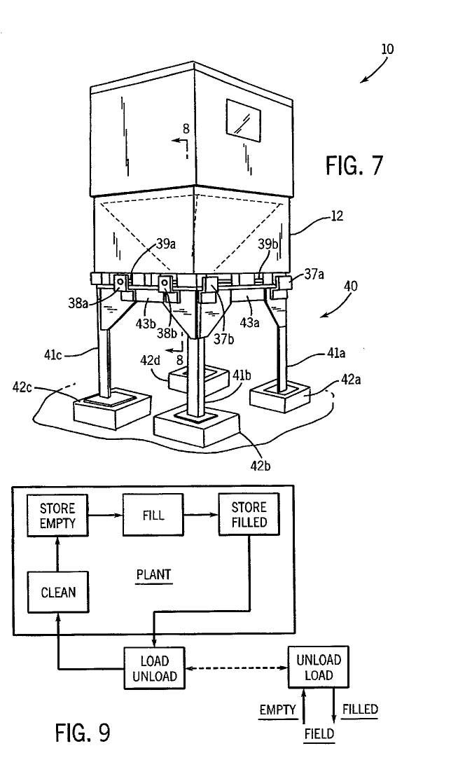

FIG. 2 illustrates bin 10 securely positioned atop trailer 20. Bin 10 is secured to trailer 20 by straps 21a-b. Trailer 20 comprises a U-shape frame 22 supported by axle 23, wheels 24a-b and drive wheel 25. The axle spans the two arms of the frame, and the drive wheel is located beneath and supports the frame under the base of the U. Motor 26 powers both drive wheel 25 and hydraulic hoist 27. Motor 26 can be of any convenient design and size, but typically it is electric (powered by a battery, not shown) and of sufficient size to provide sufficient power to operate hoist 27 to lift filled bin 10 and to maneuver trailer 20 into position so as to transfer filled bin 10 to a support rack (shown in FIG. 7). Hydraulic fluid for the operation of hoist 27 is stored in tank 19.

FIG. 3 illustrates a section of trailer 20 without bin 10. Hoist 27 is equipped with tines 28a-b that are of sufficient length so as to effectively engage the base of bin 10 to raise and lower it as required. The vertical range of tines 28a-b is such that the bin can be lowered to the ground or raised and placed onto a support rack. In another embodiment (not shown), the hoist is replaced with a crane or other means for lifting a filled bin from the trailer to the support rack.

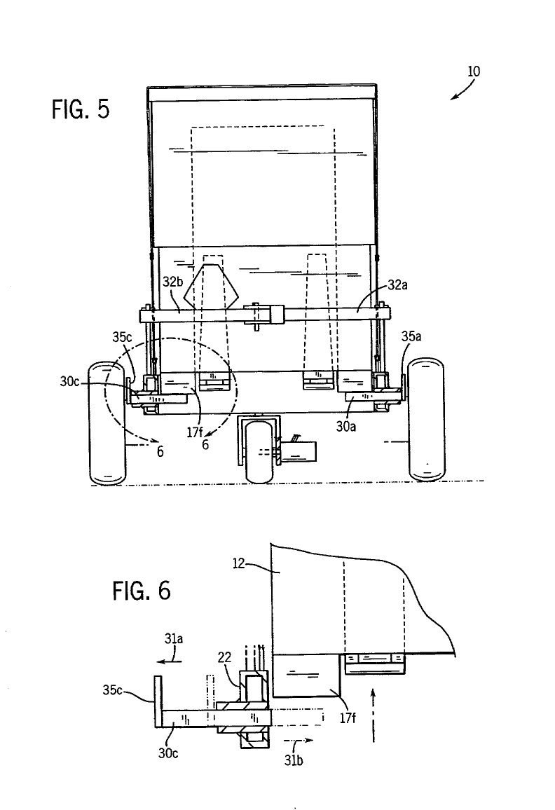

Frame 22 of trailer 20 is of a general U-shape, each arm of which is equipped with tie-down hooks 29a-d for engaging straps 21a-b (shown in FIG. 2). The arms of frame 22 are also equipped with moveable struts 30a-d that slide between a first and second position (FIG. 6). When in first position 31a, the struts are flush with or recessed into the arms of frame 22 such that the bin can be lowered to the ground. When the struts are in second position 31b, they engage bin feet 17d/f/j/l in such a manner so as to support the bin during transport (as shown in FIG. 5). The trailer rear gate comprises arms 32a-b that are pivotally mounted to the arms of frame 22 by way of posts 36a-b in a manner that allows the arms to securely join together to hold the bin in place on trailer 20 during transport, and to open in a manner that allows the bin to either be placed upon or recovered from the ground or a support rack. Preferably, one of the arms of the rear gate is equipped with traffic cautionary sign 33.

FIG. 4 is a side view of trailer 20 with a partial view of bin 10 securely attached to it. Trailer 20 is detachably engaged to a towing vehicle (not shown) by any safe and convenient means, e.g., a ball hitch (not shown). Trailer 20 is further equipped with a steering mechanism 34 that allows maneuverability of trailer 20 once decoupled from a towing vehicle. FIG. 4 (as well as FIG. 2) also shows hydraulic fluid reservoir 19 used in the operation of hoist 27.

FIGS. 5 and 6 also show that the struts are equipped with a stop tab (e.g., 35a and 35c). FIG. 5 also shows that when the feet of the bin are engaged with the struts of the trailer, tines 28a-b of the hoist do not carry any weight of the bin.

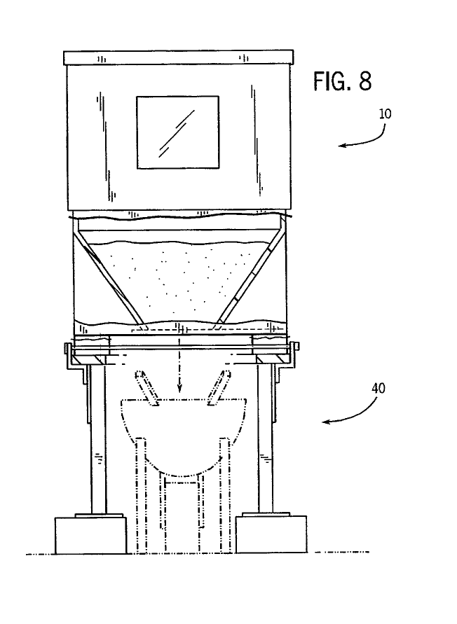

FIGS. 7-8 illustrate bin 10 positioned upon support rack 40. As shown in both of these Figures, support rack 40 comprises legs 41a-d resting upon pylons 42a-d. Support rack legs 41a-d are fastened to rails 43a-d that are joined in a configuration that conforms to bin base 12. Rack rails 43a-d are preferably joined to one another by stabilizer bars (not shown) that provide stability and rigidity to the rack. Legs 41a-d are spaced apart from one another and are of sufficient height (when resting upon the pylons) to permit a transport vehicle, e.g., a wheel barrow (shown in phantom outline in FIG. 8), to fit beneath bin 10 such that when gate 16 is in an open position, manufactured, dry, free-flowing animal feed falls through the discharge port into the transport vehicle.

Support rack 40 is also equipped with retaining tabs 37a-d (tabs 37c-d not shown) and 38a-d (tabs 38c-d not shown) all of which are fastened in any convenient manner (e.g., welds, bolts, etc.) to rails 43a-d. These tabs assist in keeping the bin and base securely in place atop the rack. Preferably, retaining tabs 38a-d are designed to receive and hold retaining bars 39a-b in such a manner that the base cannot be removed from the support rack without first unfastening the bars from the tabs. These bars serve as a safety device against inadvertent removal of base from the rack, e.g., bumping into the rack with heavy equipment, heavy winds, etc.

One sequence of steps describing the method of this invention is illustrated in the block diagram of FIG. 9. Commencing with a stored, clean and empty bin, the bin is filled and then either stored for future transport to a remote site or immediately transported to a remote site. Since one of the purposes of this invention is to provide a relatively fresh minibulk quantity of manufactured, dry animal feed to a remote site, the bins are preferably filled not more than one or two weeks in advance of their transport to the remote site of the end user.

The filled bin can be transferred to the remote site either on a predetermined schedule or in response to a demand for the delivery of a minibulk quantity of feed. With respect to the former, the schedule can either be fixed in advanced or initiated through an automated monitoring system of any convenient design (e.g., weight monitors on the bin linked to the distribution center by any convenient communication means, e.g., telephone or cable line, wireless, etc.).

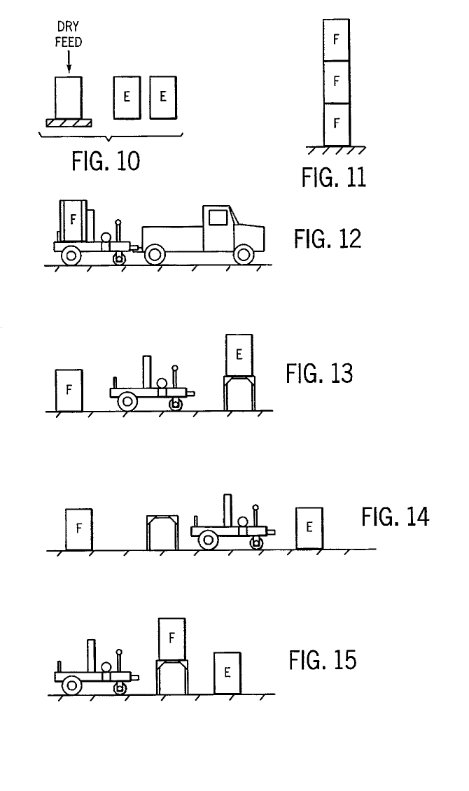

FIGS. 10-19 describe one embodiment of the sequence of steps illustrated in FIG. 9 in the context of bin 10 and trailer 20. Clean and empty bins are filled with a minibulk quantity of manufactured, dry, free-flowing animal feed (FIG. 10), and then stored until needed to transport to a remote site (FIG. 11). Bins 10 are of such of a design that they can be stored, filled or empty, in a stacked position. When needed for transport to a remote site, a bin is placed upon the trailer by any convenient means, and then secured in place with the straps and rear gate (FIG. 12). The bin can be loaded onto the trailer using the trailer hoist or another mechanical assist, e.g., a fork lift truck, crane, etc.

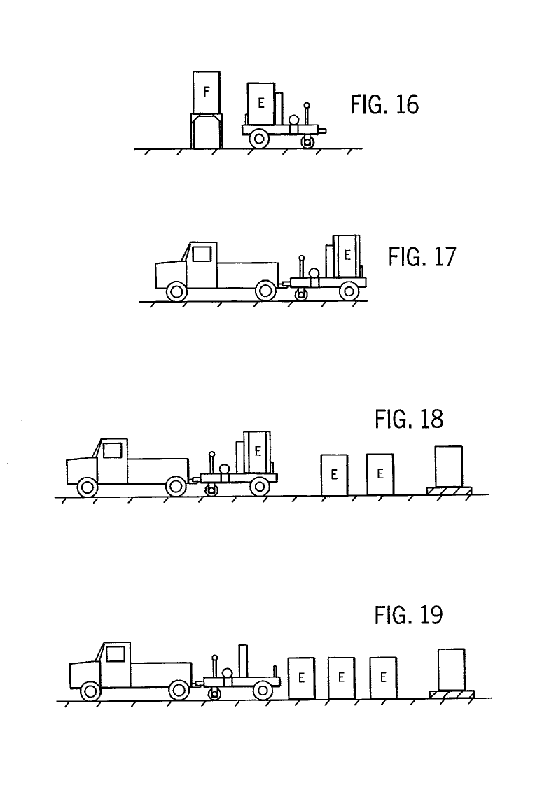

Once at the remote site, the trailer is de-coupled from the towing vehicle, and the filled bin is placed upon the ground (FIG. 13). The trailer is then maneuvered into position so that it can lower the empty bin from the support rack to the ground (FIG. 14). The arms of the trailer are spaced apart from one another sufficient to allow the arms to straddle the support rack. The trailer hoist is then used to transfer the filled container from the ground to the support rack (FIG. 15). The empty bin is then loaded onto the trailer (FIG. 16), the trailer re-coupled to the towing vehicle (FIG. 17), and the empty bin transported back to the distribution center (FIG. 18). Once at the distribution center, preferably but not necessarily, the empty bin is voided of any remaining feed, washed with soapy water, disinfected, and then dried. Once completely dry, the bin is either stored empty or immediately refilled with animal feed, and the cycle is repeated.

This invention can also be practiced in various alternative embodiments. In one such embodiment, the bin 10 is equipped with a breather vent to allow for the passage of water vapor between the interior of the bin and the environment. This minimizes, if not eliminates, condensation within the bin, and thus minimizes mold formation. The vent can either be a separate structure (not shown) on the bin, or incorporated into the design of the lid or cover.

In another alternative embodiment, the bin is a single-piece container with a discharge opening in a side wall. The bin of this embodiment has a generally rectangular or loaf shape, and the loaf bins manufactured by Rotonics Mfg., Inc. of Bartow, Fla. are representative.

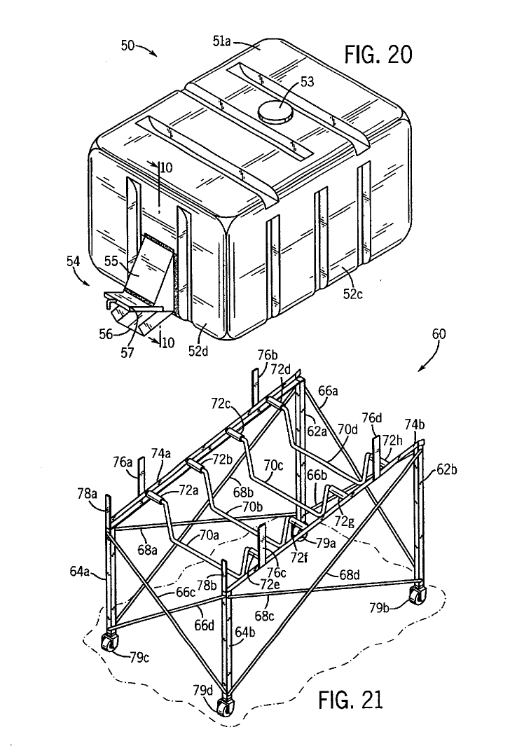

FIG. 20 illustrates loaf bin 50 comprising a top and bottom wall 51a-b (bottom wall 51b not shown) connected by side walls 52a-d (side walls 52a-b not shown). Top wall 51a is equipped with lid 53 that is in sealing engagement (e.g., threaded, compression fit, etc. and which is substantially water-tight) with an opening size for easy and fast filling of the bin with a dry, free-flowing manufactured animal feed.

In another embodiment of this invention not shown, top wall 51a is equipped with two or more openings, each opening having such a lid. In another, preferred embodiment of this invention, the fill opening is sealed with a breather cap that allows for the exchange of air between the environment and the inside of the bin so as to prevent or reduce condensation within the bin or, alternatively, the breather element is simply lid 53 loosely threaded to top wall 51a.

Side wall 52d is equipped with discharge mechanism 54 which is in sealing engagement with an opening sized for easy and fast discharge from the bin of dry, free-flowing, manufactured animal feed. Discharge mechanism 54 (also known as a hopper valve or slide gate assemble) comprises (i) adapter plate 55 that is affixed to side wall 52d by any convenient means, e.g., mechanical fasteners, adhesive, etc., in an essentially air and water-tight manner, (ii) guide or shoot 56 that attaches to adapter plate 55, and (iii) gate blade 57 (shown in the open position) that opens or closes access to the interior of bin 50. When gate blade 57 is in the close position, the bin is sealed to the environment such that the bin contents are protected from the environment and invasive animals. When gate blade 57 is in the open position, the contents of the bin are discharged. The amount of feed discharge from the bin can be regulated by manual operation of the gate blade. One discharge mechanism that can be used in the practice of this particular embodiment is the hopper valve assembly manufactured by Brock Grain & Feed Systems of Milford, Ind. Variations on this discharge mechanism include detachable or hinged chutes (which can be removed or moved to a position that does not hinder the positioning of the bin on either the transport or support rack), larger and/or wider adapter plates, different gate mechanisms, and the like.

Because a loaf bin discharges its contents from a side wall, it is positioned on an angle such that the contents of the bin flow gravitationally (i.e., under the force of gravity) towards the discharge mechanism. The size or slope of the angle (i.e., the angle formed by the bottom wall of the bin and a level section of ground) will vary with the nature of the animal feed (feed of a generally spherical shape flows more readily than a feed of a generally rectangular shape, and thus the tilt of the bin is usually less steep for the former than it is for the latter). Since loaf bins are generally rectangular, the support rack is typically designed such that the loaf bin rests at an angle (relative to a level section of ground) that allows the feed to flow gravitationally towards the discharge mechanism. Typically, the angle is at least about 30°, preferably at least about 40° and more preferably at least about 50°. This is illustrated in FIGS. 21-23.

Support rack 60 comprises a pair of rear legs 62a-b and a pair of front legs 64a-b, the rear legs longer than the front legs such that the plane between the rear and front legs is sloped downward from back to front. The rear legs are connected to the front legs. Rear leg 62a is connected to front leg 64a by top rail 74a, and similarly, rear leg 62b is connected to front leg 64b by top rail 74b. Rear legs 62a-b are connected to one another by stabilizing cross beams 66a-b, and similarly, front legs 64a-b are connected to one another by stabilizing cross beams 66c-d. Rear leg 62a is further connected to front leg 64a by stabilizing cross beams 68a-b, and similarly, rear leg 62b is further connected to front leg 64b by stabilizing cross beams 68c-d. Lateral support beams 70a-d connects top rails 74a-b and, optionally but preferably, each such beams are equipped with rollers 72a respectively. Top rail 74a is also equipped with side tabs 76a-b and end tab 78a and top rail 74b is equipped with side tabs 74c-d and end tab 78b (the tabs also known as guides, stops or a similar term). Rear legs 62a-b are optionally equipped with wheels 79a-b, respectively, and front legs 64a-b are optionally equipped with wheels 79c-d, respectively.

In those embodiments of this invention in which the bin is equipped with a stationary, nonremovable chute that extends below the bottom wall of the bin, the lateral support beams preferably are of a flattened U-shaped configuration, as shown in FIG. 21, which allows for easy movement of the bin into its final resting position on support rack 60. In those circumstances in which the chute is retractable, hinged, removable, or otherwise designed not to extend below the plane of the bottom wall of the bin during transport and/or storage, the lateral support beams can be, and preferably are, straight (i.e., extend from one lateral rail to another in a flat plane (not shown).

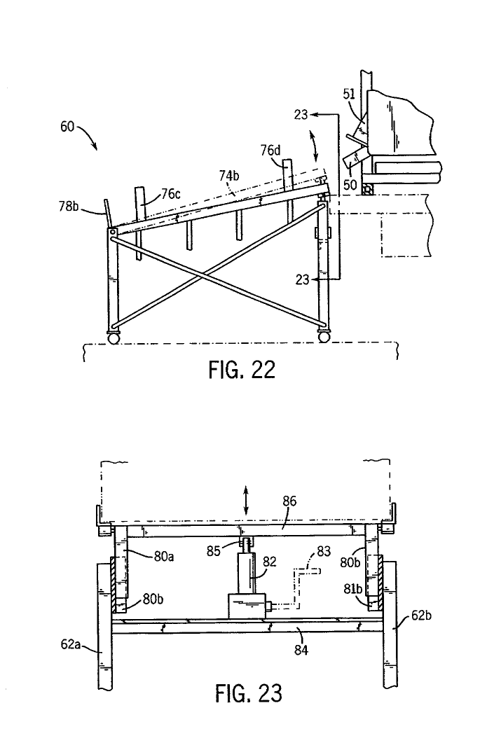

Referring to FIGS. 22 and 23, in one embodiment of this invention, top rails 74a are adjustable so as to vary the angle of incline of bin 40. The ability to adjust the angle of incline can be convenient for at least two reasons. First, it permits better and more even alignment between support rack 60 and the bed of the transport vehicle (shown in phantom). This, in turn, facilitates moving bin 40 from the transport vehicle to support rack 60 (as is self-evident, the filled bin is moved from the vehicle (depicted as a truck in FIG. 22) onto the high end of the support rack thus using gravity as an assist in positioning the bin onto the rack). Second, the ability to vary the angle of incline is useful in those instances in which the animal feed, for whatever reason, does not flow freely through the discharge mechanism. In this instance, an increased angle of incline may impart sufficient gravitational force to the feed such that it resumes free flow through the discharge mechanism.

Still referring to FIGS. 22 and 23, top rails 74a-b are joined by lateral support rail 86 which is equipped with legs 80a-b. These legs are not load-bearing support structures, but rather part of a stability/guide system that includes tabs 81a-b. When lateral support rail 86 is lifted from the top of rear legs 62a-b (upon which it rests when not in an extended position), legs 80a-b move along and against tabs 81a-b. Lateral support rail 86 is extended upward through the action of jack 82, which can be manipulated by, for instance, handle 83 (shown in phantom). Jack 82 rests upon lateral beam 84, which is fastened to rear legs 62a-b in any suitable manner (e.g., welded, bolted, etc.), and jack head 85 engages lateral support rail 86. Alternative means to this manual jack for adjusting the angle of incline can also be used in the practice of this invention, e.g., a powered, hydraulic mechanism, a hoist, etc. Moreover, jacks of different sizes and designs, e.g., a jack sized and designed to rest on the ground, can also be used.

In an alternative embodiment of this invention, the bin is carried by a simple skid, pallet or other device that allows the bin to be maneuvered with mechanical lift equipment. In these embodiments, the bin is attached to the skid by any conventional means, e.g., straps, brackets, etc. In yet another alternative embodiment, the bin is designed with lift-engagement features (e.g., ridges, hooks, pockets, handles, etc.) that allow for its positioning and transport using mechanical lifts. For example, the bin can have one or more cavities or recessions designed into the shape of its bottom wall to allow engagement with the tines of a forklift truck, or the hooks and cables of a crane.

Once the loaf bin has been transported to the desired remote location, it is transferred from the transport vehicle (e.g., trailer or truck) onto the support rack.

First, the empty bin must be moved from the support rack onto the truck. Since the empty bin is relatively light, the bin can be removed from the rack by an individual of modest strength with little difficulty. Once the empty bin is removed from the support rack, then the filled bin is transferred from the transport vehicle to the support vehicle (the truck positioned such that the filled bin first engages the support rack at its elevated end). The transfer can be effected with the use of lift equipment, e.g., a forklift truck, crane, etc. The side tabs guide the filled bin as it moves along the top rails from the transport vehicle into its position onto the support rack so as to prevent the bin from moving sideways off of the rack either during this transfer operation or while at rest in the field (from contact with an animal or machine). Alternatively, the top rails can be shaped to provide this guiding function. The end tabs prevent the bin from sliding too far forward on the support rack, also during both transfer and while at rest. Here too, the top rails can be shaped to perform this function.

Typically, the support rack and filled bin are located in a barn, pasture or similar setting in which the horses, cattle or other large animals are fed. The discharge assembly of the bin is located at a sufficient height above the floor or ground to permit a wheelbarrow or similar device to be positioned beneath the discharge device to accept feed from the bin. To release feed, the gate blade of the discharge device is activated, the desired quantity of feed is transferred to a wheelbarrow or similar device, and the gate blade is closed. The feed is then transported to a desired location. The feed remaining in the bin is safe from the elements and/or rodents until further needed. In those embodiments of the invention in which the support rack is equipped with wheels or other mobility means, e.g., skids, tracks, etc., the support rack and bin itself can be moved about the building or pasture.

In another alternative embodiment of this invention, the bin and support rack are combined into a one-piece device as shown in FIG. 24. In this instance, the bottom wall of the bin is equipped with legs 44a-d (leg 44d not shown). The legs (44b-c) that extend beneath the wall with discharge gate 45 are shorter than the legs (44a and d) extending beneath the wall distal to discharge gate 45. The relative length of legs 44a and d and 44b-c are determined by the desired angle of incline for the bottom wall of the bin. Typically, the angle of incline is at least about 30 degrees, preferably at least 40 degrees, and more preferably at least 50 degrees. These angles of incline are essentially the same as those used with the bin and support rack of FIGS. 21-23. The bin of FIG. 24 is also equipped with capped fill portal 46.

In yet another alternative embodiment, the bin of FIG. 24 is of a two-piece construction (not shown) in which the bin is of a configuration as shown in FIG. 20 and the support rack is simply a modified, four-legged table design with its supporting surface having the desired angle of inclination.

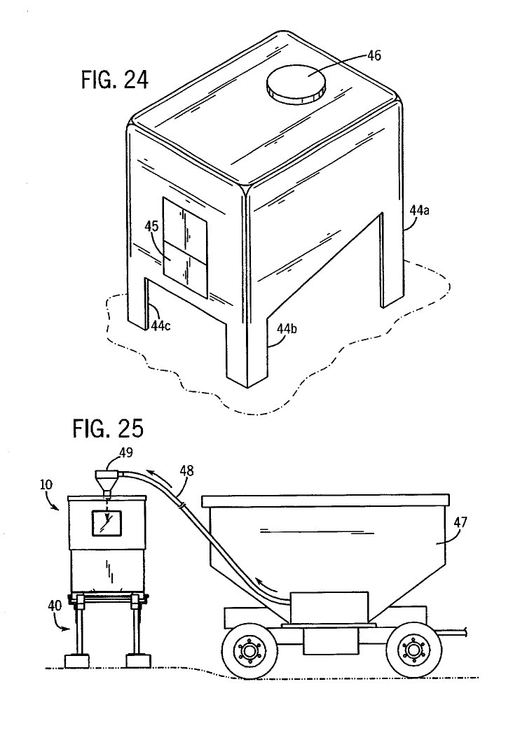

FIG. 25 illustrates still another embodiment of this invention. In this embodiment, the bin of FIG. 7 remains on the rack of FIG. 7, i.e., it is not removed for refilling once emptied of its contents. Rather, once empty or otherwise in need of refilling, the bin is refilled in place by any convenient means. As illustrated in the FIG. 25, one means of refilling bin 10 is from a cargo vehicle, e.g., hopper trailer 47, that is towed or otherwise transported to the bin. This cargo vehicle is designed to hold more than a minibulk quantity of feed, typically many times a minibulk quantity of feed, so that one such vehicle can be used to fill many minibulk feed bins before requiring reloading.

Once at the site, the dry, free-flowing manufactured animal feed is transferred from hopper trailer 47 to bin 10 by any convenient means, e.g., an air flow system comprising hose 48 and dispenser head 49 powered by any suitable source (gas engine, battery, etc, not shown). One such system is available from Systems One (a Yetter Company). An alternative transfer means utilizes an auger system. The refilling can occur on an as-needed basis, e.g., when the bin is empty or the amount of feed is reduced to below or near a level of less than a minibulk quantity, or on a predetermined schedule.

Although this invention has been described in considerable detail through the description and figures described above, this detail is for the purpose of illustration and is not to be construed as limitations upon the invention as described in the appended claims.

1. A method for delivering minibulk quantities of dry, free-flowing manufactured animal feed to sites remote from a distribution center for the feed, the method comprising the steps of:
A. Filling a container with a minibulk quantity of the feed at a distribution center for the feed, the container equipped with at least one sealable fill and discharge opening through which the feed can be loaded into and unloaded from the container;
B. Transporting the filled container to the site remote from the center;
C. Positioning the filled container onto a support rack at the site remote from the distribution center, the filled container positioned upon the support rack in a manner such that the feed flows under the force of gravity to the at least one sealable opening of the container;
D. Recovering a container depleted of feed from the remote site; and
E. Returning the container depleted of feed to the distribution center for refilling with feed.

2. The method of claim 1 in which the container is equipped with at least one sealable fill opening and at least one sealable discharge opening, and is sized to hold between about 500 and about 3,000 pounds of feed.

3. The method of claim 2 in which the container comprises a ring (i) fitted with a removable lid, and (ii) in sealed engagement with a base comprising a bottom wall, the bottom wall comprising a sealable discharge port.

4. The method of claim 3 in which the container is transported to the remote site atop a trailer equipped with a hoist, motor, drive wheel and steering mechanism.

5. The method of claim 4 in which the rack is constructed so that the container is held at a height such that a transport vehicle can be positioned beneath the discharge opening of the container.

6. The method of claim 5 in which the container is moved from the trailer to the rack using the trailer hoist.

7. The method of claim 6 in which the trailer is positioned using the trailer drive wheel so that the container is moved from the trailer to the rack.

8. The method of claim 7 in which the container depleted of feed is recovered from the rack using the trailer hoist, and is returned to the distribution center atop the trailer.

9. The method of claim 2 in which the container is a loaf bin of a unitary plastic construction and sized to hold between about 500 and about 3000 pounds of feed.

10. The method of claim 9 in which the bin is positioned upon the rack with at least a 30 degree angle of inclination.

11. The method of claim 9 in which the bin is filled and transported in combination with a transport rack.

12. The method of claim 1 in which the container and rack comprise an integrated, one piece unit.

13. A minibulk animal feed assembly comprising:
A. A transport and storage bin for holding a minibulk quantity of manufactured, free-flowing, dry animal feed, the bin equipped with at least one sealable fill and discharge opening through which the feed can be loaded into and unloaded from the bin; and
B. A rack comprising legs spaced apart and of sufficient height to permit a transport vehicle to fit beneath the discharge opening of the bin.

14. The assembly of claim 13 in which the bin is equipped with at least one sealable fill opening and at least one sealable discharge opening, and is sized to hold between about 500 and about 3,000 pounds of feed.

15. The assembly of claim 14 in which the bin comprises a ring (i) fitted with a removable lid, and (ii) in sealed engagement with a base comprising a bottom wall, the bottom wall comprising a sealable discharge port.

16. The assembly of claim 14 in which the bin is a loaf bin of a unitary plastic construction and sized to hold between about 500 and about 3000 pounds of feed.

17. The assembly of claim 16 in which the rack comprises a plurality of rear legs and a plurality of front legs, the rear legs connected to the front legs by a plurality of top rails, the rear legs longer than the front legs such that the plane between the rear and front legs is sloped downward from back to front so as to define an angle of incline.

18. The assembly of claim 17 in which the bin comprises top, bottom and side walls, and includes at least one sealable opening in the top wall that is sized for filling the bin with the feed and at least one sealable opening in a side wall that is sized for discharging the feed from the bin.

19. The assembly of claim 18 in which the bin includes a discharge mechanism that is in sealing engagement with the at least one opening sized for discharging the feed from the bin.

20. The assembly of claim 14 in which the bin is constructed from a durable plastic.

21. The assembly of claim 17 in which the top rails are equipped with tabs.

22. The assembly of claim 21 in which the bin is supported on the rack at an angle of incline is at least about 30 degrees.

23. The assembly of claim 15 in which the rack is constructed so that the container is held at a height such that a transport vehicle can be positioned beneath the discharge opening of the container.

24. A minibulk animal feed assembly for transporting and holding a minibulk quantity of manufactured, free-flowing, dry animal feed, the assembly comprising an integrated, one-piece bin and rack.

25. A trailer for (i) coupling to a towing vehicle, and (ii) transporting a container holding a minibulk quantity of a manufactured, free-flowing, dry animal feed, the trailer comprising:
A. A U-shaped frame comprising two arms and a base, the frame supported by (i) an axle and a set of wheels, the axle spanning the arms of the frame, and (ii) a drive wheel located beneath the base of the frame;
B. A hoist set atop the frame;
C. A motor operationally connected to the drive wheel and hoist; and
D. A steering mechanism for maneuvering the trailer under the power of the motor and drive wheel once the trailer is de-coupled from the towing vehicle.

26. The trailer of claim 25 in which the hoist is equipped with tines for engaging the container in manner that facilitates loading and unloading the container onto and from the trailer.

27. The trailer of claim 26 in which the arms are equipped with tie-down hooks for engaging straps with which to secure the container to the trailer.

28. The trailer of claim 27 in which the arms are equipped further with moveable struts upon which the container sits while during transport.

29. The trailer of claim 28 in which the arms are equipped further with a rear gate comprising first and second members, the first member pivotly connected to one arm of the trailer and the second member pivotly connected to the other arm of the trailer.

30. The trailer of claim 29 in combination with a container holding a minibulk quantity of a manufactured, free-flowing, dry animal feed, the container comprising at least one sealable fill opening and at least one sealable discharge opening, and sized to hold between about 500 and about 3,000 pounds of feed.

31. The combination of claim 30 in which the container comprises a ring (i) fitted with a removable lid, and (ii) in sealed engagement with a base comprising a bottom wall, the bottom wall comprising a sealable discharge port.

32. A method for maintaining minibulk quantities of dry, free-flowing manufactured animal feed at sites remote from a distribution center for the feed, the method comprising:
A. Providing an assembly comprising (i) a storage bin for holding a minibulk quantity of manufactured, free-flowing, dry animal feed, the bin equipped with at least one sealable fill and discharge opening through which the feed can be loaded into and unloaded from the bin, and (ii) a rack comprising legs spaced apart and of sufficient height to permit a transport vehicle to fit beneath the discharge opening of the bin, the bin positioned atop the rack.
B. Transporting the feed from the distribution center to the remote site in a vehicle designed for transporting quantities of feed in excess of minibulk quantities; and
C. Transferring the feed from the transport vehicle to the bin on an as-needed basis to maintain in or restore to the bin a minibulk quantity of feed after feed has been removed from the bin.
